(19) United States
(12) Patent Application Publication
(10) Pub. No.: US 2015/0187043 A1
(43) Pub. Date: Jul. 2, 2015

(54) VIRTUALIZING STORAGE STRUCTURES WITH UNIFIED HEAP ARCHITECTURE

(71) Applicant: SAMSUNG ELECTRONICS COMPANY, LTD., SUWON CITY (KR)

(72) Inventors: Michael C. Shebanow, SAN JOSE, CA (US); MAGNUS EKMAN, ALAMEDA, CA (US)

(73) Assignee: SAMSUNG ELECTRONICS COMPANY, LTD., SUWON CITY (KR)

(21) Appl. No.: 14/142,628

(22) Filed: Dec. 27, 2013

(51) Int. Cl. G06T 1/60; G06F 12/02

(52) U.S. Cl. CPC G06T 1/60; G06F 12/023

(57) ABSTRACT

A method for storage allocation for a graphical processing unit includes maintaining a unified storage structure for the graphical processing unit. Multiple physical storage structures are virtualized in the unified storage structure by dynamically forming multiple logical storage structures from the unified storage structure for the multiple physical storage structures.

### TECHNICAL FIELD

One or more embodiments generally relate to a graphical processing unit (GPU) and, in particular, to a dynamic configurable GPU and reduction of GPU data movement.

### BACKGROUND

Graphical processing units (GPUs) are primarily used to perform graphics rendering. A GPU typically contains a number of different physical storage structures. Examples of such structures may include: register file (RF), first level instruction cache (L1I$), first level data cache (L1D$), first level constant cache (L1C$), texture cache (T$), and second level cache (L2$). With this GPU architecture, at design time a trade-off occurs in determining an amount of chip area to dedicate to each of these physical structures. A factor for this determination is that the optimal area allocation is different for different applications that will run on the GPU. That is, the chosen allocation may be a compromise and cannot be tailored to each specific application.

### SUMMARY

One or more embodiments generally relate to a dynamic configurable GPU and reduction of GPU data movement. In one embodiment, a method provides for storage allocation for a graphical processing unit. In one embodiment, the method includes maintaining a unified storage structure for the graphical processing unit. In one embodiment, multiple physical storage structures are virtualized in the unified storage structure by dynamically forming multiple logical storage structures from the unified storage structure for the multiple physical storage structures.

In one embodiment a non-transitory computer-readable medium having instructions which when executed on a computer perform a method comprising maintaining a unified storage structure for a graphical processing unit. In one embodiment, multiple physical storage structures are virtualized in the unified storage structure by dynamically forming a plurality of logical storage structures from the unified storage structure for the multiple physical storage structures.

In one embodiment, a graphics processor for an electronic device comprises: one or more processing elements coupled to a memory heap device. In one embodiment, the memory heap device comprises: a physical memory structure including a plurality of logical storage structures representing a plurality of physical storage structures. In one embodiment, the plurality of logical storage structures are each mapped into the physical memory structure. In one embodiment, a shared memory storage device is dynamically shared between each of the plurality of logical storage structures.

These and other aspects and advantages of one or more embodiments will become apparent from the following detailed description, which, when taken in conjunction with the drawings, illustrate by way of example the principles of the one or more embodiments.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 shows a schematic view of a communications system, according to an embodiment.

FIG. 2 shows a block diagram of an architecture for a system including a mobile device including a graphical processing unit (GPU) module, according to an embodiment.

FIG. 3 shows an example GPU with multiple physical storage devices.

FIG. 4 shows a GPU with a unified storage structure with logically mapped storage devices, according to an embodiment.

FIG. 5 shows a unified storage structure with a dynamically shared storage device, according to an embodiment.

FIG. 6 shows an example pointer-based metadata mapping for the unified storage structure, according to an embodiment.

FIG. 7 shows an example of fixed mapping for the unified storage structure, according to an embodiment.

FIG. 8 shows an example metadata structure for a buffer, according to an embodiment.

FIG. 9 shows an example array with valid-bits, according to an embodiment.

FIG. 10 shows a circular buffer, according to an embodiment.

FIG. 11 shows an example block diagram of a graphics pipeline showing portions that are logically mapped into a unified storage structure, according to an embodiment.

FIG. 12 shows a block diagram for a process for logically mapping physical storage devices into a unified storage structure for a GPU, according to one embodiment.

FIG. 13 is a high-level block diagram showing an information processing system comprising a computing system implementing one or more embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments provide a dynamically configurable GPU and reduction of GPU data movement using a unified storage device for logically mapping physical storage devices to the unified storage device. In one embodiment, a unified heap architecture (UHA) is used for unifying the separate GPU physical memory storage structures into a single physical structure or UHA. In one embodiment, the various logical structures are then mapped into the heap. Examples of mapped storage structures are the register file, a plane equation table, a primitive mapping table, thread descriptor queues, a graphics state table, first level instruction cache, first level data cache, first level constant cache, texture cache, and second level cache.

In one embodiment, the storage structures that are mapped to the UHA may be divided into categories, such as (1) cache structures, and (2) fixed structures. In one embodiment, some metadata is needed to represent the storage structures. In one embodiment, the UHA structure is implemented as multiple banks of random access memory (RAM), such as static RAM (SRAM), etc. In one or more embodiments, multiple alternatives are used to organize the UHA structure, such as: pointer-based mapping (pointers and optionally size descriptors are used in implementing the storage structures and point to locations within a storage structure); fixed mapping (there is fixed mapping from a particular logical structure of the UHA heap structure and a location in the storage structure, and a separate portion of the UHA structure identifies the current use of the specific location of the UHA structure; and hybrid of pointer-based and fixed-based mapping (i.e., some storage structures use pointers while other storage structures use fixed mapping).

In one embodiment, a method provides for storage allocation for a GPU. In one embodiment, the method includes maintaining a unified storage structure for the GPU. In one embodiment, multiple physical storage structures are virtualized in the unified storage structure by dynamically forming multiple logical storage structures from the unified storage structure for the multiple physical storage structures.

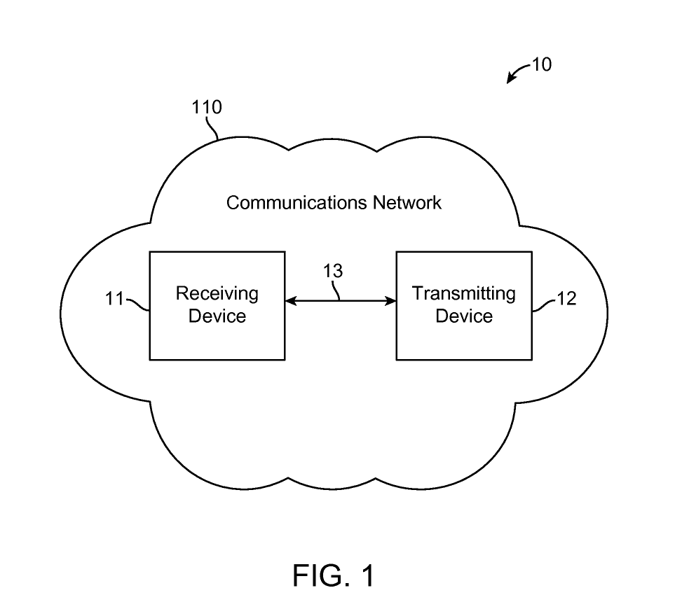

FIG. 1 is a schematic view of a communications system 10, in accordance with one embodiment. Communications system 10 may include a communications device that initiates an outgoing communications operation (transmitting device 12) and a communications network 110, which transmitting device 12 may use to initiate and conduct communications operations with other communications devices within communications network 110. For example, communications system 10 may include a communication device that receives the communications operation from the transmitting device 12 (receiving device 11). Although communications system 10 may include multiple transmitting devices 12 and receiving devices 11, only one of each is shown in FIG. 1 to simplify the drawing.

Any suitable circuitry, device, system or combination of these (e.g., a wireless communications infrastructure including communications towers and telecommunications servers) operative to create a communications network may be used to create communications network 110. Communications network 110 may be capable of providing communications using any suitable communications protocol. In some embodiments, communications network 110 may support, for example, traditional telephone lines, cable television, Wi-Fi (e.g., an IEEE 802.11 protocol), Bluetooth®, high frequency systems (e.g., 900 MHz, 2.4 GHz, and 5.6 GHz communication systems), infrared, other relatively localized wireless communication protocol, or any combination thereof. In some embodiments, the communications network 110 may support protocols used by wireless and cellular phones and personal email devices (e.g., a Blackberry®). Such protocols can include, for example, GSM, GSM plus EDGE, CDMA, quadband, and other cellular protocols. In another example, a long range communications protocol can include Wi-Fi and protocols for placing or receiving calls using VOIP, LAN, WAN, or other TCP-IP based communication protocols. The transmitting device 12 and receiving device 11, when located within communications network 110, may communicate over a bidirectional communication path such as path 13, or over two unidirectional communication paths. Both the transmitting device 12 and receiving device 11 may be capable of initiating a communications operation and receiving an initiated communications operation.

The transmitting device 12 and receiving device 11 may include any suitable device for sending and receiving communications operations. For example, the transmitting device 12 and receiving device 11 may include a mobile telephone devices, television systems, cameras, camcorders, a device with audio video capabilities, tablets, wearable devices, and any other device capable of communicating wirelessly (with or without the aid of a wireless-enabling accessory system) or via wired pathways (e.g., using traditional telephone wires). The communications operations may include any suitable form of communications, including for example, voice communications (e.g., telephone calls), data communications (e.g., e-mails, text messages, media messages), video communication, or combinations of these (e.g., video conferences).

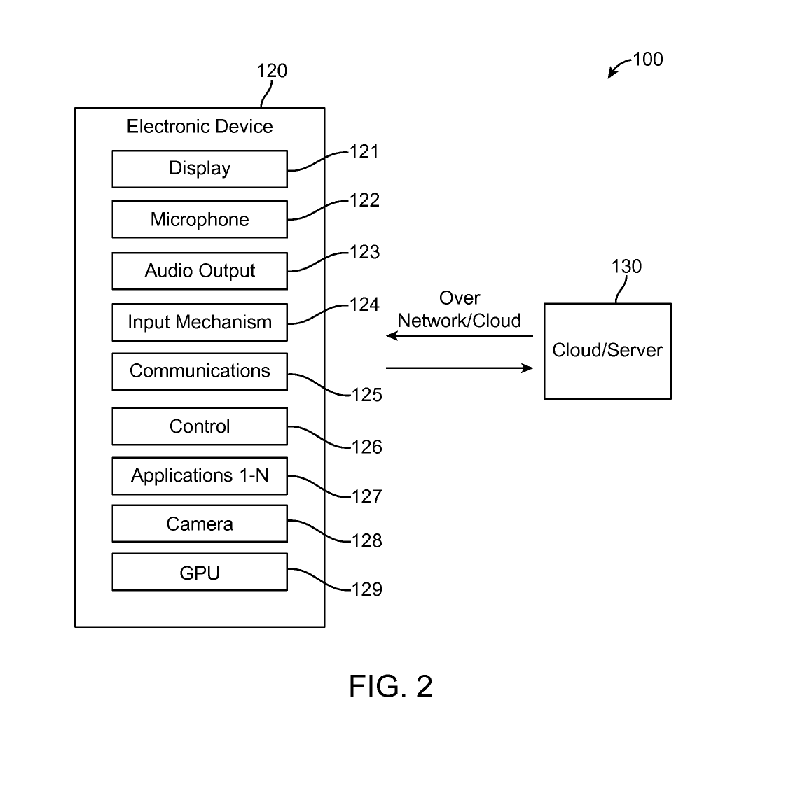

FIG. 2 shows a functional block diagram of an architecture system 100 that may be used for graphics processing in an electronic device 120. Both the transmitting device 12 and receiving device 11 may include some or all of the features of the electronics device 120. In one embodiment, the electronic device 120 may comprise a display 121, a microphone 122, an audio output 123, an input mechanism 124, communications circuitry 125, control circuitry 126, a camera module 128, a GPU module 129, and any other suitable components. In one embodiment, applications 1-N 127 are provided and may be obtained from a cloud or server 130, a communications network 110, etc., where N is a positive integer equal to or greater than 1.

In one embodiment, all of the applications employed by the audio output 123, the display 121, input mechanism 124, communications circuitry 125, and the microphone 122 may be interconnected and managed by control circuitry 126. In one example, a handheld music player capable of transmitting music to other tuning devices may be incorporated into the electronics device 120.

In one embodiment, the audio output 123 may include any suitable audio component for providing audio to the user of electronics device 120. For example, audio output 123 may include one or more speakers (e.g., mono or stereo speakers) built into the electronics device 120. In some embodiments, the audio output 123 may include an audio component that is remotely coupled to the electronics device 120. For example, the audio output 123 may include a headset, headphones, or earbuds that may be coupled to communications device with a wire (e.g., coupled to electronics device 120 with a jack) or wirelessly (e.g., Bluetooth® headphones or a Bluetooth® headset).

In one embodiment, the display 121 may include any suitable screen or projection system for providing a display visible to the user. For example, display 121 may include a screen (e.g., an LCD screen) that is incorporated in the electronics device 120. As another example, display 121 may include a movable display or a projecting system for providing a display of content on a surface remote from electronics device 120 (e.g., a video projector). Display 121 may be operative to display content (e.g., information regarding communications operations or information regarding available media selections) under the direction of control circuitry 126.

In one embodiment, input mechanism 124 may be any suitable mechanism or user interface for providing user inputs or instructions to electronics device 120. Input mechanism 124 may take a variety of forms, such as a button, keypad, dial, a click wheel, or a touch screen. The input mechanism 124 may include a multi-touch screen.

In one embodiment, communications circuitry 125 may be any suitable communications circuitry operative to connect to a communications network (e.g., communications network 110, FIG. 1) and to transmit communications operations and media from the electronics device 120 to other devices within the communications network. Communications circuitry 125 may be operative to interface with the communications network using any suitable communications protocol such as, for example, Wi-Fi (e.g., an IEEE 802.11 protocol), Bluetooth®, high frequency systems (e.g., 900 MHz, 2.4 GHz, and 5.6 GHz communication systems), infrared, GSM, GSM plus EDGE, CDMA, quadband, and other cellular protocols, VOIP, TCP-IP, or any other suitable protocol.

In some embodiments, communications circuitry 125 may be operative to create a communications network using any suitable communications protocol. For example, communications circuitry 125 may create a short-range communications network using a short-range communications protocol to connect to other communications devices. For example, communications circuitry 125 may be operative to create a local communications network using the Bluetooth® protocol to couple the electronics device 120 with a Bluetooth® headset.

In one embodiment, control circuitry 126 may be operative to control the operations and performance of the electronics device 120. Control circuitry 126 may include, for example, a processor, a bus (e.g., for sending instructions to the other components of the electronics device 120), memory, storage, or any other suitable component for controlling the operations of the electronics device 120. In some embodiments, a processor may drive the display and process inputs received from the user interface. The memory and storage may include, for example, cache, Flash memory, ROM, and/or RAM/DRAM. In some embodiments, memory may be specifically dedicated to storing firmware (e.g., for device applications such as an operating system, user interface functions, and processor functions). In some embodiments, memory may be operative to store information related to other devices with which the electronics device 120 performs communications operations (e.g., saving contact information related to communications operations or storing information related to different media types and media items selected by the user).

In one embodiment, the control circuitry 126 may be operative to perform the operations of one or more applications implemented on the electronics device 120. Any suitable number or type of applications may be implemented. Although the following discussion will enumerate different applications, it will be understood that some or all of the applications may be combined into one or more applications. For example, the electronics device 120 may include an automatic speech recognition (ASR) application, a dialog application, a map application, a media application (e.g., QuickTime, MobileMusic.app, or MobileVideo.app), social networking applications (e.g., Facebook®, Twitter®, Etc.), an Internet browsing application, etc. In some embodiments, the electronics device 120 may include one or multiple applications operative to perform communications operations. For example, the electronics device 120 may include a messaging application, a mail application, a voicemail application, an instant messaging application (e.g., for chatting), a videoconferencing application, a fax application, or any other suitable application for performing any suitable communications operation.

In some embodiments, the electronics device 120 may include a microphone 122. For example, electronics device 120 may include microphone 122 to allow the user to transmit audio (e.g., voice audio) for speech control and navigation of applications 1-N 127, during a communications operation or as a means of establishing a communications operation or as an alternative to using a physical user interface. The microphone 122 may be incorporated in the electronics device 120, or may be remotely coupled to the electronics device 120. For example, the microphone 122 may be incorporated in wired headphones, the microphone 122 may be incorporated in a wireless headset, the microphone 122 may be incorporated in a remote control device, etc.

In one embodiment, the camera module 128 comprises one or more camera devices that include functionality for capturing still and video images, editing functionality, communication interoperability for sending, sharing, etc., photos/videos, etc.

In one embodiment, the GPU module 129 comprises processes and/or programs for processing images and portions of images for rendering on the display 121 (e.g., 2D or 3D images). In one or more embodiments, the GPU module may comprise GPU hardware and memory (e.g., a unified heap architecture (UHA) 410 (FIG. 4), SRAM, DRAM, processing cores/elements, cache, etc.).

In one embodiment, the electronics device 120 may include any other component suitable for performing a communications operation. For example, the electronics device 120 may include a power supply, ports, or interfaces for coupling to a host device, a secondary input mechanism (e.g., an ON/OFF switch), or any other suitable component.

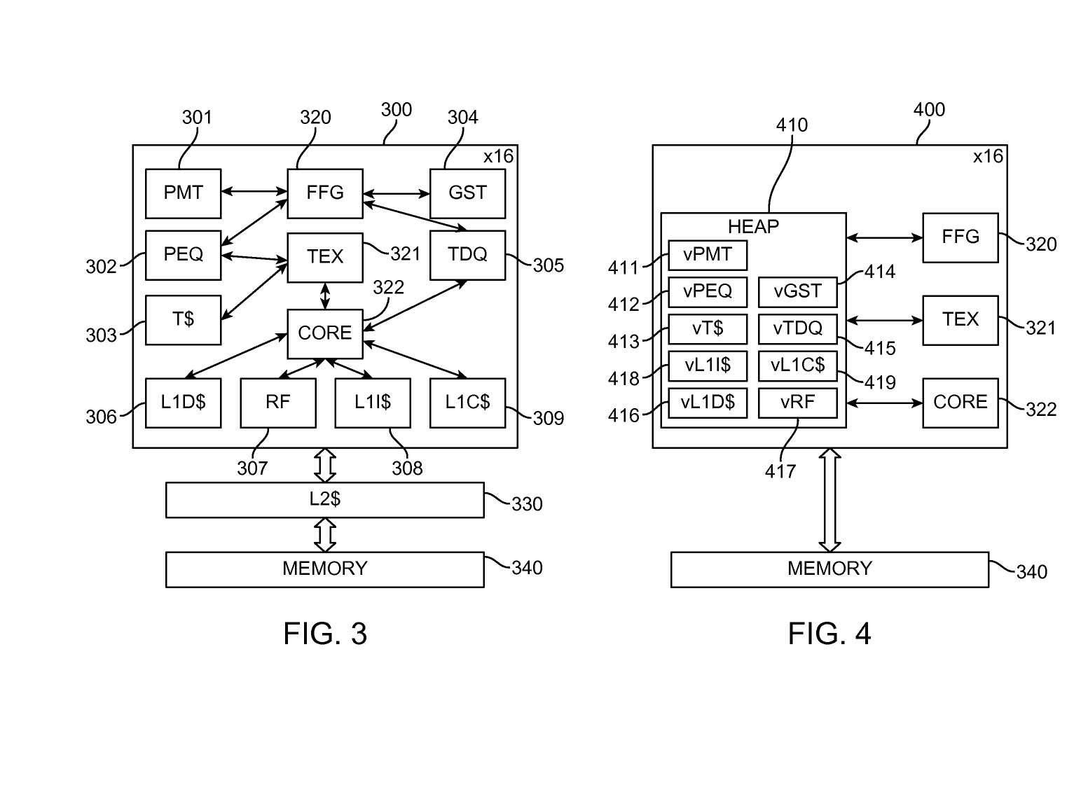

FIG. 3 shows an example GPU 300 with multiple physical storage devices. In the example GPU 300, the GPU 300 includes physical memory structures for: primitive mapping table (PMT) 301, plane equation table (PEQ) 302, texture cache (T$) 303, graphics state table (GST) 304, thread descriptor queues (TDQ) 305, first level data cache (L1D$) 306, register file (RF) 307, first level instruction cache (L1I$) 308, and first level constant cache (L1C$) 309. The GPU 300 also includes fixed function graphics (FFG) 320, texture unit (TEX) 321, and a shader/processing core 322. The GPU 300 is connected with a second level cache (L2$) 330 and memory device 340 (e.g., RAM, SRAM, DRAM, etc.). The GPU 300 is made with fixed sized memory structures and data movement is conducted between the various structures, as indicated by the multiple arrows.

FIG. 4 shows a GPU 400 with a unified storage structure 410 with logically mapped (e.g., virtualized) storage devices (411-419), according to an embodiment. In one embodiment, the unified storage structure 410 is a unified heap storage structure or UHA. In one embodiment, the logically mapped storage devices comprise a virtual PMT (vPMT) 411, a virtual PEQ (vPEQ) 412, a virtual T$ (vT$) 413, a virtual GST (vGST) 414, a virtual TDQ (vTDQ) 415, a virtual L1D$ (vL1D$) 416, a virtual RF (vRF) 417, a virtual L1I$ (vL1I$) 418 and a virtual L1C$ (vL1C$) 419. In one embodiment, L2$ 330 (FIG. 3) may also be virtualized and logically mapped into the UHA 410. In one embodiment, the FFG 320, TEX 321 and core 322 communicate with the UHA 410 and logically mapped storage devices 411-419 and move data in the direction of the arrows. In one embodiment, the GPU 400 is coupled with the memory 340.

In one or more embodiments, the boundary between the logically mapped storage structures 411-419 may be chosen dynamically so that the allocation is the best allocation for a currently running application on an electronic device (e.g., electronic device 120) using the GPU 400. In one example embodiment, if one application benefits more from having a large register file than it benefits from having a large data cache, then more of the UHA 410 physical structure may be used as a register file for that application (e.g., allocating more of the UHA 410 storage to the vRF 417). Similarly, if another application may benefit more from a large data cache, then the GPU 400 using the UHA 410 may be configured to allocate more of the storage space of the UHA 410 to the logical data cache (e.g., vL1D$ 416). One or more embodiments provide the ability to tailor the allocation to the currently running application, which results in a more efficient working point (e.g., higher performance and/or lower power dissipation) as compared with architectures that would otherwise be limited in memory structure size at the time of manufacturing (e.g., GPU 300, FIG. 3).

One or more embodiments provide for data movement elimination since the various physical structures are mapped logically in the same physical structure (e.g., UHA 410). In one example embodiment, instead of physically moving data from the second level cache into the texture cache, the texture cache may be implemented as vT$ 413 so that it just references the data in its current location. In one embodiment, the ability to eliminate data movement results in a more power efficient design than architectures that require data movement between multiple physical devices (e.g., GPU 300, FIG. 3).

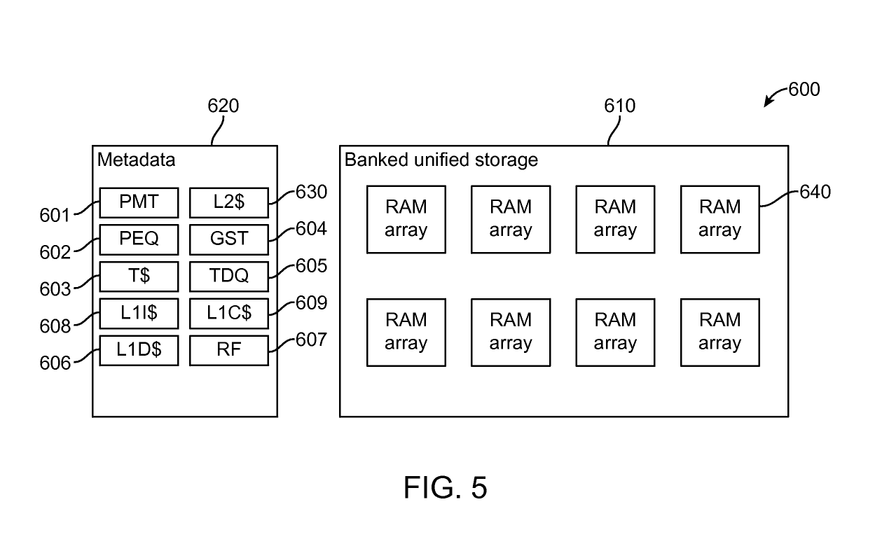

FIG. 5 shows a unified storage structure or UHA 600 showing details with a metadata structure 620 and a dynamically shared storage device 610, according to an embodiment. In one embodiment, the logical structures (e.g., the logically mapped storage structures 411-419) that are mapped to the UHA 600 may be divided into two major categories: cache structures and fixed structures. In one embodiment, the cache structures have the property that a tag lookup is needed to determine if a specific piece of data is present in the UHA 600 or not, and when present, where the exact location is. In one embodiment, an example of a cache structure is the L1 data cache. Fixed structures have the property that once they are allocated, it is known that a specific piece of data is present in the UHA 600, and its exact location is also known (i.e., the exact location of a piece of data is known if the exact location of the structure is known. For example, if a register file is allocated at a specific location, then it is known where a particular register in that register file is located. But the location of the register file must be known). In one example embodiment, a base pointer+size as metadata is used for determining the exact location of a particular piece of data. In one embodiment, an example of a fixed structure is the register file.

In one embodiment, for both of cache and fixed structure categories, some metadata is needed. In one embodiment, in the case of cache structures, the metadata may consist of a tag array. In one embodiment, for fixed structures, the metadata contains the necessary information to fully identify the data region, e.g., one or more base pointers with associated size descriptors. In one embodiment, fixed structures may have more complex metadata structures than just a base pointer and size descriptor. In one example embodiment, if the fixed structure virtualizes an array of records, then the metadata may consist of a bit vector that indicates valid records in addition to the base pointer and the size descriptor. In another example embodiment, if the fixed structure virtualizes a circular buffer, the metadata may consist of a head and a tail pointer in addition to the base pointer and the size descriptor. In one embodiment, the metadata is not part of the UHA 600 itself, but is a necessary building block of the UHA 600.

In one embodiment, the UHA 600 comprises metadata 620 representing all the logically mapped storage structures 411-419 as well as unified storage 610 that is dynamically shared between the logically mapped storage structures 411-419. In one embodiment, metadata for the logically mapped storage structures 411-419 is represented as metadata: PMT 601, PEQ 602, T$603, GST 604, TDQ 605, L1D$ 606, RF 607, L1I$ 608, L1C$ 609 and L2$ 630. In one embodiment, the shared unified storage 610 may comprise a banked unified storage device including multiple arrays of memory (e.g., RAM arrays 640).

In one embodiment, although all the metadata 620 is shown as grouped into a single metadata structure in FIG. 5, other embodiments may split the metadata 620 into another number of groups (e.g., 2, 3, 4, etc.). In one example embodiment, some of the metadata structures 601-609 and 630 may be located inside or in conjunction to a unit or module that accesses it. In one example embodiment, the metadata for the texture cache (T$ 603) which has the form of cache tags may be located inside a texture unit. In one embodiment, is should be noted that all metadata 620 is not necessarily of the same format.

In one embodiment, a number of ways of organizing the metadata structures 601-609 and 630 for a UHA 600 may be implemented. In one example, different logical metadata structures may map to disjoint regions of the shared storage 610. In another example embodiment, the different metadata structures map to overlapping locations, which may result in avoided data moves between structures (which results in lower power dissipation).

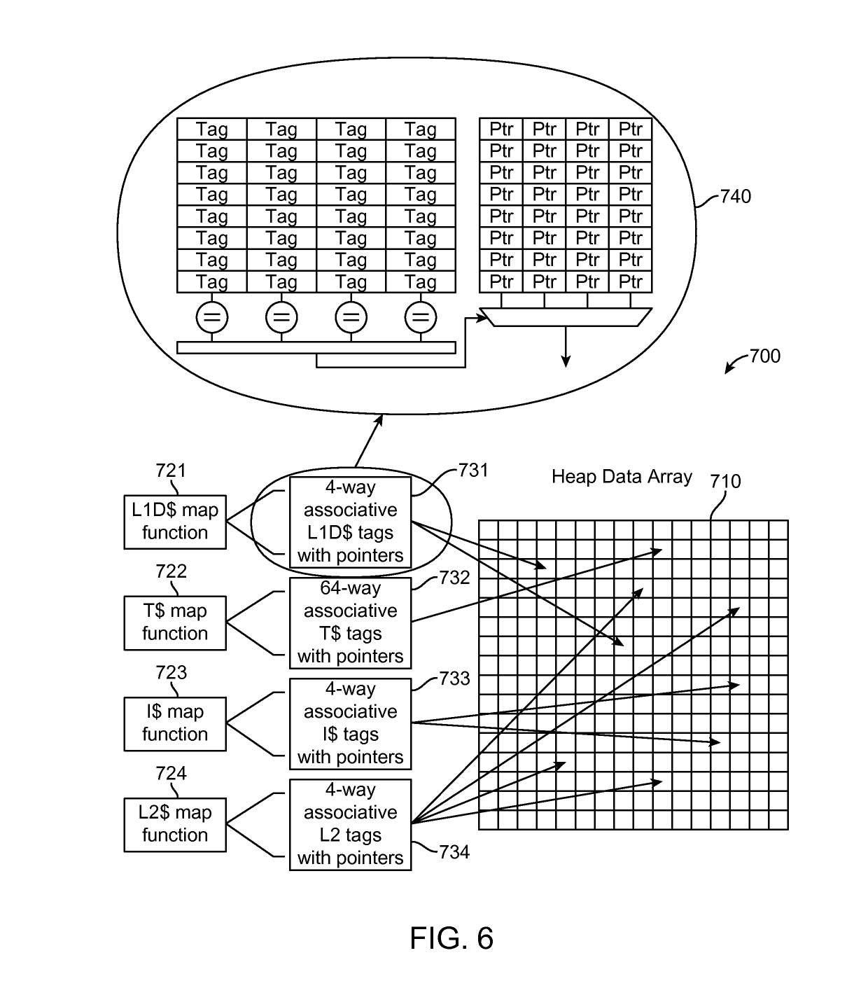

FIG. 6 shows an example pointer-based metadata mapping 700 for the unified storage structure (e.g., UHA 410, FIG. 4, UHA 600, FIG. 5), according to an embodiment. In one embodiment, with pointer based mapping, each metadata structure contains pointers and optionally associated size descriptors that identify regions in the unified storage structure array 710. In one embodiment, the pointers point to cache lines that are of fixed size so size descriptors are not necessary. In one embodiment, one pointer per tag is used, and multiple pointers exist per tag structure. In one example embodiment, in order to implement an L1 data cache (L1D$) in the unified storage structure as vL1D$ 416, the metadata representing the L1D$ (e.g., L1D$ 606) would include a tag array 731 illustrated in detail as array 740 (e.g., similar to a traditional cache implementation), but instead of a coupled data array, it has a pointer array which identifies the location of each cache line. In one example embodiment, the pointer array 740 shows the implementation of a 4-way associative tag store with eight (8) sets. In one or more embodiments, the metadata for the L1D$ cache is not just a pointer or remapping, but contains actual comparison logic as well.

In one embodiment, for pointer-based metadata mapping, the metadata structures use map functions (e.g., L1D$ map function 721, T$ map function 722, 1$ map function 723, L2$ map function 724, etc.) for mapping into an array of tags and pointers, e.g., 4-way associative L1D$ tags with pointers array 731 (shown in example detail as array 740), 64-way associative T$ tags with pointers array 732, 4-way associative 1$ tags with pointers 733, 4-way associative L2 tags with pointers 734, etc.

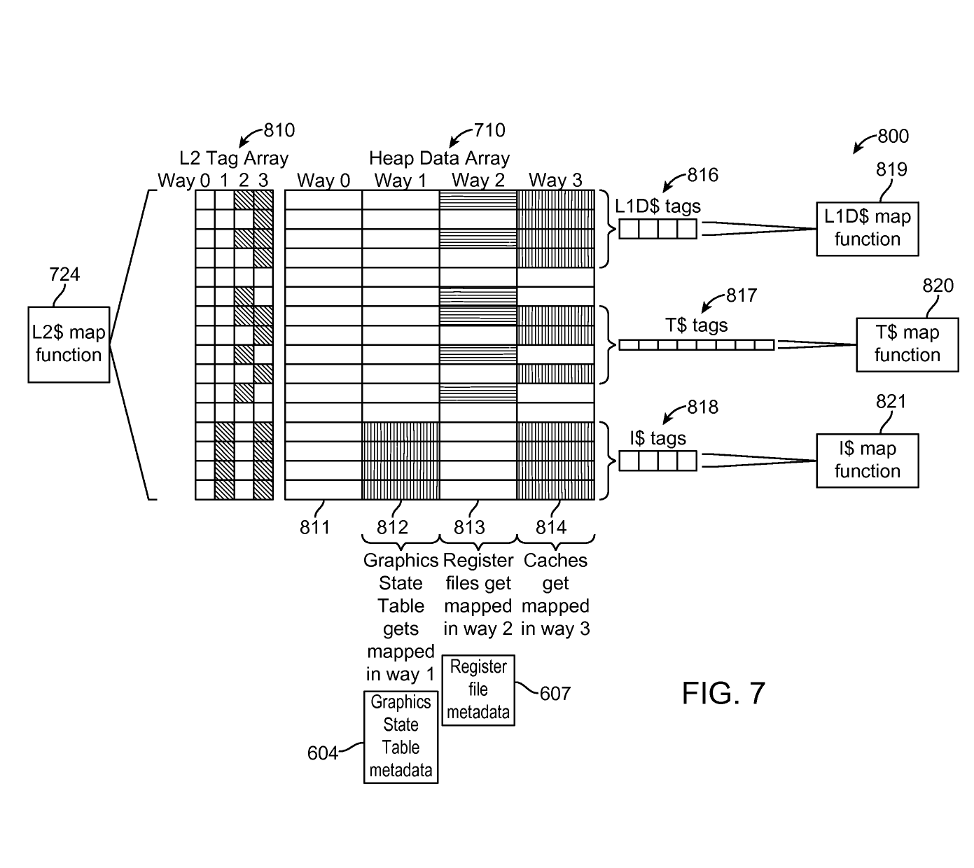

FIG. 7 shows an example of fixed mapping 800 for the unified storage structure (e.g., UHA 410, FIG. 4, UHA 600, FIG. 5), according to an embodiment. In one embodiment, instead of pointer based metadata mapping 700 (FIG. 6), there may be a fixed mapping between metadata and storage locations, and a separate piece of metadata that describes the current usage of a specific location. In one embodiment, the fixed mapping 800 eliminates the need for pointers. In one example embodiment, the tag structures are similar to the tag structure described in pointer-based mapping 700, but there is no pointer associated with each tag.

In one example embodiment, the L2$ map function 724 is arranged for forming an L2 tag array 810 and the unified storage structure array 710, with way 0 811, way 1 812, way 2 813 and way 3 814. In one embodiment, the L2 tag array 810 represents the second level cache. In one example embodiment, a fixed mapping from each tag in the L2 tag array 810 to a location in the unified storage structure array 710. In one embodiment, the tags span the entire cache. In one example embodiment, the right side of FIG. 7 shows tag arrays for first level data cache L1D$ tag array 816, texture cache T$ tag array 817 and instruction cache 1$ tag array 818.

In one embodiment, the L1D$, T$ and 1$ may have different associativity than the L2$ and may have different (but fixed) mapping functions into the shared data array. In one embodiment, the data address) of the L1D$ tag array 816 is input to the L1D$ map function 819, the data from the T$ tag array 817 is input to the T$ map function 820 and the data from the 1$ tag array 818 is input to the 1$ map function 821, where each function then operates to provide separate mapping operations.

In one example embodiment, the GST metadata 604 is mapped into way 1 812, the RF metadata 607 indicates that the register file is mapped into way 2 813, and the caches are mapped into way 3 814.

In one example embodiment, the L2$ tags are augmented with a bit indicating if the line is part of the L2 cache or if it is used for another structure. Similarly, the tags for the other structures are augmented with a similar bit. In one example embodiment, the bit determines if the corresponding tag should participate in tag matching on a cache lookup. In one embodiment, the fixed mappings are carefully chosen to ensure that a cache always has at least one way enabled for each set. In one example embodiment, it would be made improper to choose mappings that result in that an entire row in the unified storage structure array 710 to get “blacked out.”

In one example embodiment, a hybrid mapping scheme is built where one or more structures (e.g., the L2$) have a fixed mapping (e.g., fixed mapping 800) and the other structures have a pointer-based mapping (e.g., pointer-based mapping 700, FIG. 6). In one example embodiment, some metadata structures are not organized as tags. In one example embodiment, the RF metadata 607 indicates that the register file is mapped into way 2 813 and graphics state GST metadata 604 that is mapped into way 1 812 are examples of such structures that are not organized as tags.

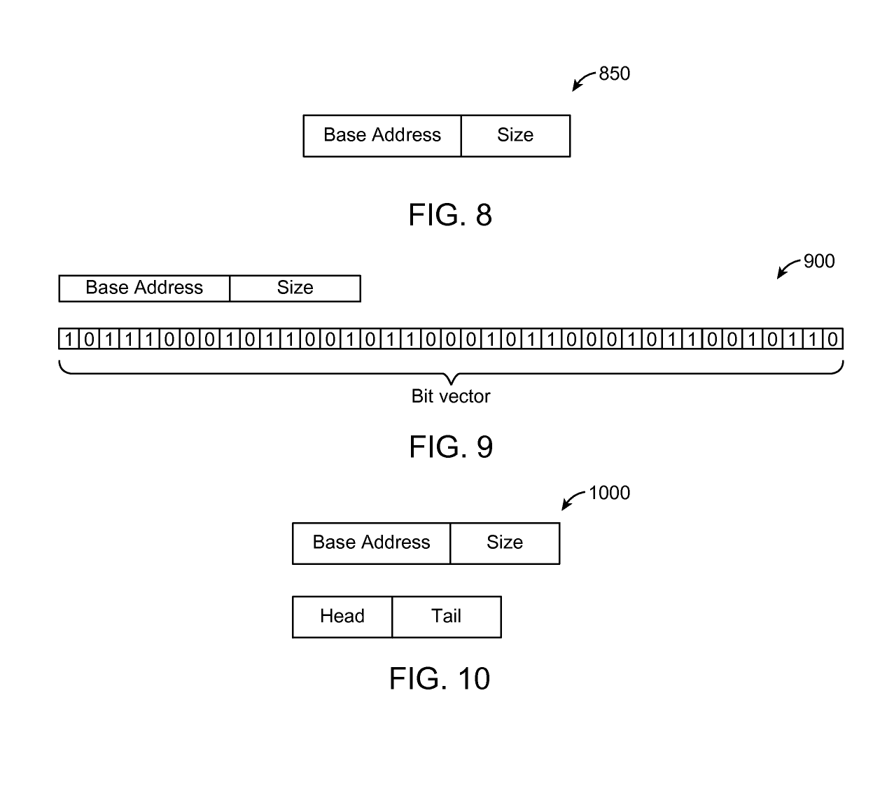

FIG. 8 shows an example metadata structure for a buffer 850, according to an embodiment. In one embodiment, if a fixed sized buffer (e.g., buffer 850) is needed, then metadata may be handled as a base pointer and a size descriptor as shown in buffer 850. In one example embodiment, buffer 850 is used for the PEQ 302, for example in system 1100 (FIG. 11).

FIG. 9 shows an example array 900 with valid-bits, according to an embodiment. In one embodiment, if an array with valid-bits (or other indicating type bits) is needed, then the metadata is somewhat more complex. In one example embodiment, in addition to the base address and the size descriptor, there is a bit associated with each entry in the array as shown in the array 900. In one example embodiment, the array 900 is used for the TDQ 305, for example in system 1100 (FIG. 11).

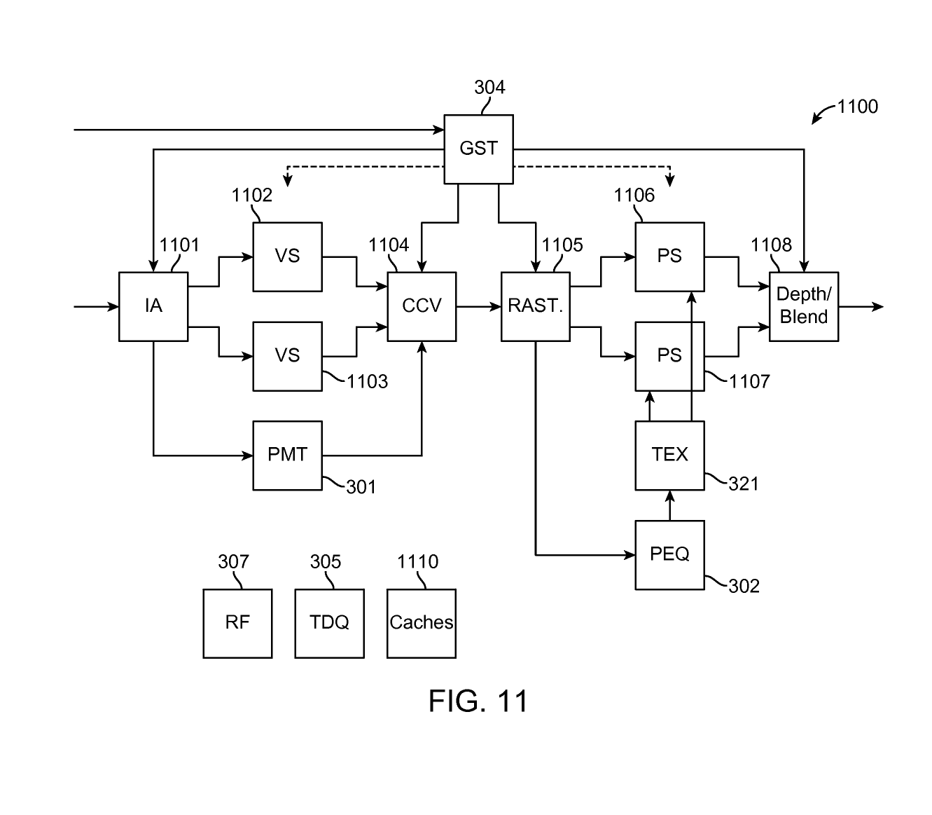

FIG. 10 shows a circular buffer 1000, according to an embodiment. In one embodiment, in order to implement a circular buffer 1000, a head and tail pointer are needed (in addition to the base address and size). In one example embodiment, the circular buffer 1000 is used for the GST 304, for example in system 1100 (FIG. 11).

In one embodiment, the UHA structure (e.g., UHA 410, FIG. 4, UHA 600, FIG. 5) needs a strategy for dynamically managing the shared storage. In one or more embodiments, management techniques that may be used are described as follows. In one example embodiment, a software controlled memory management technique may be employed. In one example embodiment, the software controlled memory management technique simplifies the hardware implementation, but prohibits very frequent adjustments of structure sizes. In one example embodiment, software may be used from a graphics driver.

In one example embodiment, a free-list based memory management technique is employed. In one example embodiment, unused portions of the UHA (e.g., UHA 410, FIG. 4, UHA 600, FIG. 5) are organized in a data structure (e.g., a linked list) that is organized to easily identify, add and remove chunks to dynamically allocate/de-allocate the chunks to one of the multiple logical structures that are virtualized by the UHA.

In one example embodiment, a bit vector-based memory management technique is employed. In one example embodiment, a possible problem with the free-list based memory management technique is that the shared storage itself needs to be accessed to perform memory allocation operations, which consumes some of the available bandwidth. In one example embodiment, a separate metadata structure of bit vectors is maintained where each bit represents a specific region in the shared storage. In one example embodiment, the bits of the bit vectors indicate if the region is currently allocated or not.

In one embodiment, a combination of two or more of the above mentioned techniques may be employed. In one example embodiment, the UHA may be semi-statically divided into multiple regions by the driver and allocations inside one of the regions may be controlled using bit vectors and the others may use a free-list.

FIG. 11 shows a block diagram of an example graphics pipeline system 1100 showing portions that are logically mapped into a unified storage structure (e.g., UHA 410, FIG. 4, UHA 600, FIG. 5), according to an embodiment. It should be noted that other graphics pipelines with additional/different elements may also be used in one or more embodiments. In one example embodiment, the system 1100 shows a simple graphics pipeline. The blocks including input assembler (IA) 1101, vertex shader (VS) 1102 and 1103, clip cull and viewport (CCV) 1104, rasterizer (RAST) 1105, pixel shader (PS) 1106 and 1107, TEX 321 and depth/blend stage 1108 mainly do computations, while the storage structures PMT 301, GST 304, TDQ 305, RF 307 and caches 1110 (e.g., T$, L1D$, L1I$, L1C$, L2$) are virtualized by the UHA.

In one example embodiment, draw commands enter the pipeline 1100 from the graphics driver (or optionally from a command processor) into the IA 1101. In one example embodiment, associated with a draw command is a graphics state (GS) (the current state of the OpenGL state machine for a pipeline implementing the OpenGL API, the current state of a Direct3D implemented pipeline, etc.). In one embodiment, the GS is written into the GST 304. In one example embodiment, the GST 304 is implemented as a circular buffer in the UHA. In one example embodiment, space for the GST 304 is originally allocated by the graphics driver and its location is defined by a base pointer and a size descriptor, and additionally has an associated tail and head pointer that describes the region that currently contains the GS. In one example embodiment, when a new GS is written into the GST 304, the tail pointer is modified, and when it is later removed from the GST 304 the head pointer is modified. GS is used by a large number of units in the pipeline 1100 (for simplification, not all connections are shown in pipeline 1100).

In one example embodiment, the IA 1101 fetches vertices and other information from memory. The IA 1101 writes primitive mappings into the PMT 301 that is virtualized into the UHA. In one embodiment, the PMT 301 is managed like a circular buffer. In one embodiment, the IA 1101 also creates VS 1102/1103 threads. In one example embodiment, the corresponding thread descriptors are written into the TDQ 305 (there may be multiple TDQs 305). In one example embodiment, arbitration logic will launch VS threads and PS threads onto the shader cores (the shader cores show up twice in the pipeline 1100 as VS 1102/1103 and PS 1106/1107 since a unified shader core is used). In one embodiment, the shader cores may also be used for a geometry shader, compute shader, hull shader, etc. In one embodiment, the TDQ 305 is virtualized as an array in the UHA.

In one embodiment, even as a thread is launched onto a shader core, it stays in the TDQ 305 virtualized array, but a corresponding bit in the TDQ metadata structure (e.g., TDQ metadata 605, FIG. 5) indicates that the thread is now running. In one embodiment, in order to launch a thread, a corresponding register file needs to be allocated. In one example embodiment, it is assumed that space for register files are tracked by bit vectors (metadata) that enable fast coalescing.

In one example embodiment, when the VS 1102/1103 performs a memory request, it does so by first checking one or more of the caches in the memory hierarchy. In one embodiment, the caches 1110 are virtualized into the UHA. In one embodiment, the caches 1110 have traditional tag structures outside of the UHA that indicates if the data is present in the UHA. In one embodiment, if the data is present in the UHA, it may be located using a particular mapping function. In one embodiment, it is assumed that the mapping between a particular tag and a heap location is fixed and decided at design time.

In one embodiment, output from the VS 1102/1103 goes to the CCV unit 1104. In one embodiment, the CCV unit 1104 reads primitive mappings from the PMT 301 and output from the VS 1102/1103 and passes primitives that pass the clip and cull test to the RAST 1105. In one embodiment, if a primitive mapping is not needed anymore, the CCV unit 1104 instructs the PMT metadata structure (e.g., PMT metadata 601, FIG. 5) to update the head pointer.

In one embodiment, the RAST 1105 creates plane equations and writes them into the PEQ 302 which is virtualized by the UHA. In one example embodiment, the PEQ 302 has been allocated as a fixed size structure and is fully defined by a base pointer and a size descriptor. In one example embodiment, the RAST 1105 also creates pixel shader threads and writes them into the TDQ 305 and updates appropriate metadata (e.g., clearing bits to indicate that the threads are not yet launched). In one embodiment, in order to create pixel shader threads, register files need to be allocated just as for vertex shader threads.

In one embodiment, as threads are launched onto the shader core (enters the PS 1106/1107 stage), the corresponding metadata bits are set to indicate that they have been launched. In one embodiment, the PS 1106/1107 often does texture requests through the TEX 321, which accesses the PEQ 302. In one embodiment, the PS 1106/1107 also does memory accesses through the texture cache.

In one embodiment, output from the PS 1106/1107 goes to the depth and blend 1108 stage. In one embodiment, the depth and blend 1108 stage performs depth testing and blending as defined by the GS that is virtualized in the UHA. In one example embodiment, this is the last stage in the example graphics pipeline 1100.

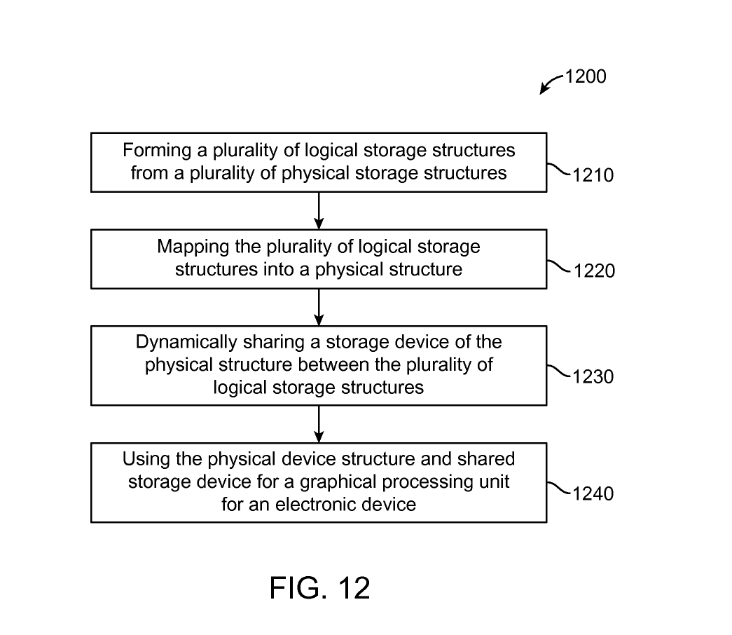

FIG. 12 shows a block diagram for a process 1200 for logically mapping physical storage devices into a unified storage structure (e.g., UHA 410, FIG. 4, UHA 600, FIG. 5) for a GPU (e.g., GPU 400), according to one embodiment. In one embodiment, the process 1200 provides for storage allocation for a GPU. In one embodiment, in process 1200 a unified storage structure is maintained for the GPU where multiple physical storage structures are virtualized in the unified storage structure by dynamically forming multiple logical storage structures from the unified storage structure for the multiple physical storage structures. In one embodiment, in block 1210 a plurality of logical storage structures are formed for a plurality of physical storage structures. In one embodiment, the virtual physical structures comprise one or more of a register file, a plane equation table, a primitive mapping table, thread descriptor queues, a graphics state table, a first level instruction cache, a first level data cache, a first level constant cache, a texture cache, and a second level cache, etc.

In one embodiment, in block 1220 the plurality of logical storage structures are mapped into a physical device structure. In one embodiment, the physical device structure comprises a unified storage structure or UHA. In one embodiment, in block 1230 a storage device (e.g., storage device 610, FIG. 5) of the physical device structure or UHA is dynamically shared between the plurality of logical storage structures.

In one example embodiment, in block 1240 the physical device structure and shared storage device are used for a GPU (e.g., GPU 400, FIG. 4) for an electronic device (e.g., electronic device 120, FIG. 2). In one embodiment, the plurality of physical storage structures comprise cache memory structures requiring a lookup for determining if data is present in the physical device structure, and fixed memory structures that require allocation for determining if data is present in the physical device structure. In one embodiment, in process 1200 metadata is required for cache memory structures and the fixed memory structures.

In one embodiment, in process 1200 the metadata is stored in one or more dedicated metadata structures (e.g., metadata structures 620, FIG. 5), and the shared storage device (e.g., shared storage device 610, FIG. 5) comprises a plurality of memory arrays (e.g., RAM, SRAM, DRAM, etc., arrays). In one embodiment, in process 1200 the one or more metadata structures comprise pointers into the unified storage structure. In one embodiment, unused space in the unified storage structure is tracked using one or more of a free-list, and metadata organized as bit vectors.

In one embodiment, in process 1200 a fixed mapping exists between the one or more metadata structures and locations in the shared storage device. In one embodiment, in process 1200 a portion of the one or more metadata structures contain pointers into the unified storage structure and a fixed mapping exists between metadata structures without pointers into the unified storage structure and the unified storage structure. In one embodiment, in process 1200 unused space in the unified storage structure is tracked using a combination of a free-list and metadata organized as bit vectors.

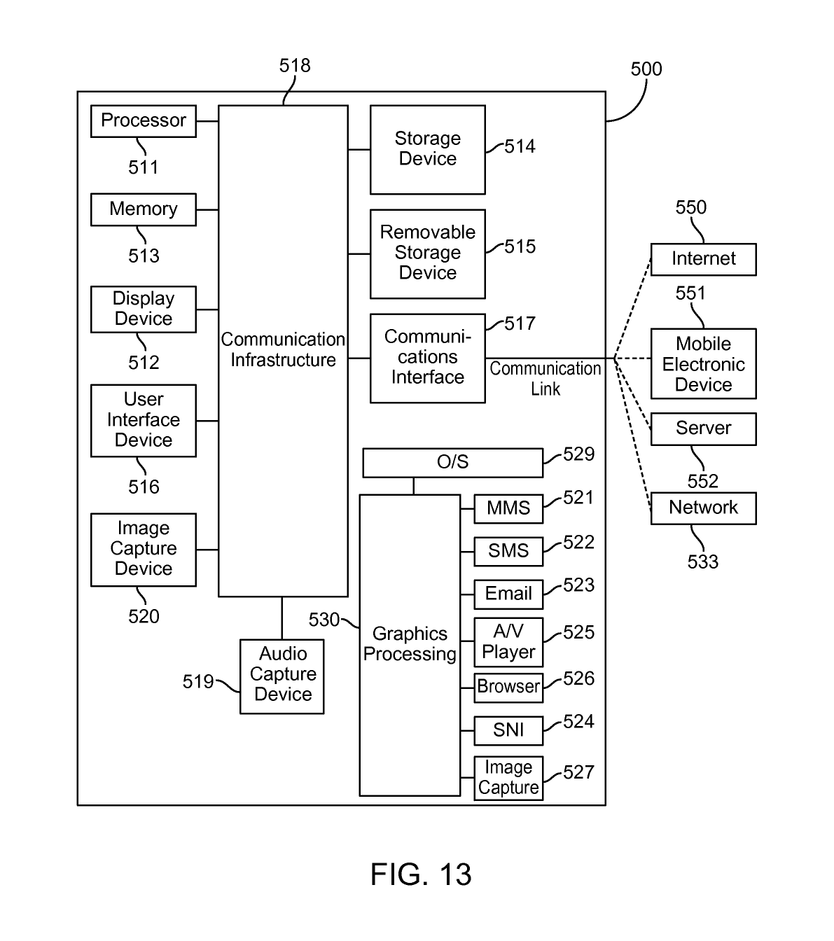

FIG. 13 is a high-level block diagram showing an information processing system comprising a computing system 500 implementing one or more embodiments. The system 500 includes one or more processors 511 (e.g., ASIC, CPU, etc.), and may further include an electronic display device 512 (for displaying graphics, text, and other data), a main memory 513 (e.g., random access memory (RAM), cache devices, etc.), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as Wi-Fi, Cellular), a network interface (such as an Ethernet card), a communications port, or a PCMCIA slot and card).

The communication interface 517 allows software and data to be transferred between the computer system and external devices through the Internet 550, mobile electronic device 551, a server 552, a network 553, etc. The system 500 further includes a communications infrastructure 518 (e.g., a communications bus, cross-over bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels.

In one implementation of one or more embodiments in a mobile wireless device (e.g., a mobile phone, tablet, wearable device, etc.), the system 500 further includes an image capture device 520, such as a camera 128 (FIG. 2), and an audio capture device 519, such as a microphone 122 (FIG. 2). The system 500 may further include application modules as MMS module 521, SMS module 522, email module 523, social network interface (SNI) module 524, audio/video (AV) player 525, web browser 526, image capture module 527, etc.

In one embodiment, the system 500 includes a graphics processing module 530 that may implement processing similar as described regarding the UHA 410 (FIG. 4), the unified storage structure 600 (FIG. 5), pipeline 1100 (FIG. 11) with logical mapping to a UHA. In one embodiment, the graphics processing module 530 may implement the process of flowchart 1200 (FIG. 12). In one embodiment, the graphics processing module 530 along with an operating system 529 may be implemented as executable code residing in a memory of the system 500. In another embodiment, the graphics processing module 530 may be provided in hardware, firmware, etc.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

One or more embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the embodiments have been described with reference to certain versions thereof; however, other versions are possible. Therefore, the spirit and scope of the appended claims should not be limited to the description of the preferred versions contained herein.

What is claimed is:

1. A method of storage allocation for a graphical processing unit, the method comprising:
maintaining a unified storage structure for a graphical processing unit; and
virtualizing multiple physical storage structures in the unified storage structure by dynamically forming a plurality of logical storage structures from the unified storage structure for the multiple physical storage structures.

2. The method of claim 1, wherein the plurality of physical storage structures comprise cache memory structures requiring a lookup for determining if data is present in the unified storage structure, and fixed memory structures that require allocation for determining if data is present in the unified storage structure, wherein metadata is required for cache memory structures and the fixed memory structures.

3. The method of claim 2, wherein virtualizing comprises:
forming a plurality of logical storage structures for the plurality of physical storage structures; and
mapping the plurality of logical storage structures into the unified storage structure, wherein a shared storage device of the unified storage structure is dynamically shared between the plurality of logical storage structures.

4. The method of claim 3, wherein the metadata is stored in one or more dedicated metadata structures, and the shared storage device comprises a plurality of memory arrays.

5. The method of claim 4, wherein the one or more metadata structures comprises pointers into the unified storage structure.

6. The method of claim 5, wherein unused space in the unified storage structure is tracked using one or more of a free-list, and metadata organized as bit vectors.

7. The method of claim 4, wherein a fixed mapping exists between the one or more metadata structures and locations in the shared storage device.

8. The method of claim 7, wherein unused space in the unified storage structure is tracked using metadata organized as bit vectors.

9. The method of claim 4, wherein a portion of the one or more metadata structures contain pointers into the unified storage structure and a fixed mapping exists between metadata structures without pointers into the unified storage structure and the unified storage structure.

10. The method of claim 9, wherein unused space in the unified storage structure is tracked using a combination of a free-list and metadata organized as bit vectors.

11. The method of claim 1, wherein the virtualized multiple physical structures comprise one or more of: a register file, a plane equation table, a primitive mapping table, thread descriptor queues, a graphics state table, a first level instruction cache, a first level data cache, a first level constant cache, a texture cache, and a second level cache.

12. The method of claim 1, wherein the graphical processing unit is used by a mobile electronic device.

13. A non-transitory computer-readable medium having instructions which when executed on a computer perform a method comprising:
maintaining a unified storage structure for a graphical processing unit; and
virtualizing multiple physical storage structures in the unified storage structure by dynamically forming a plurality of logical storage structures from the unified storage structure for the multiple physical storage structures.

14. The medium of claim 13, wherein the plurality of physical storage structures comprise cache memory structures requiring a lookup for determining if data is present in the unified storage structure, and fixed memory structures that require allocation for determining if data is present in the unified storage structure, wherein metadata is required for cache memory structures and the fixed memory structures.

15. The medium of claim 14, wherein virtualizing comprises:
forming a plurality of logical storage structures for the plurality of physical storage structures; and
mapping the plurality of logical storage structures into the unified storage structure, wherein a shared storage device of the unified storage structure is dynamically shared between the plurality of logical storage structures.

16. The medium of claim 15, wherein the metadata is stored in one or more dedicated metadata structures, and the shared storage device comprises a plurality of memory arrays.

17. The medium of claim 16, wherein the one or more metadata structures comprises pointers into the unified storage structure, and wherein unused space in the unified storage structure is tracked using one or more of a free-list, and metadata organized as bit vectors.

18. The medium of claim 16, wherein a fixed mapping exists between the one or more metadata structures and locations in the shared storage device, and wherein unused space in the unified storage structure is tracked using metadata organized as bit vectors.

19. The medium of claim 16, wherein a portion of the one or more metadata structures contain pointers into the unified storage structure and a fixed mapping exists between metadata structures without pointers into the unified storage structure and the unified storage structure, and wherein unused space in the unified storage structure is tracked using a combination of a free-list and metadata organized as bit vectors.

20. The medium of claim 13, wherein the virtualized multiple physical structures comprise one or more of: a register file, a plane equation table, a primitive mapping table, thread descriptor queues, a graphics state table, a first level instruction cache, a first level data cache, a first level constant cache, a texture cache, and a second level cache.

21. The medium of claim 13, wherein the graphical processing unit is used for a mobile electronic device.

22. A graphics processor for an electronic device comprising:
one or more processing elements coupled to a memory heap device, wherein the memory heap device comprises:
a physical memory structure including a plurality of logical storage structures representing a plurality of physical storage structures, wherein the plurality of logical storage structures are each mapped into the physical memory structure; and
a shared memory storage device that is dynamically shared between the plurality of logical storage structures.

23. The graphics processor of claim 22, wherein the plurality of physical storage structures comprise cache memory structures requiring a lookup for determining if data is present in the physical structure, and fixed memory structures that require allocation for determining if data is present in the physical memory structure.

24. The graphics processor of claim 23, wherein metadata is required for cache memory structures and the fixed memory structures.

25. The graphics processor of claim 24, wherein the metadata is stored in one or more dedicated metadata structures of the physical memory structure, and the shared memory storage device comprises a plurality of memory arrays.

26. The graphics processor of claim 25, wherein the one or more metadata structures comprises pointers into the physical memory structure, and wherein unused space in the physical memory structure is tracked using one or more of a free-list, and metadata organized as bit vectors.

27. The graphics processor of claim 25, wherein a fixed mapping exists between the one or more metadata structures and locations in the shared memory storage device, and wherein unused space in the physical memory structure is tracked using metadata organized as bit vectors.

28. The graphics processor of claim 25, wherein a portion of the one or more metadata structures contain pointers into the physical memory structure and a fixed mapping exists between metadata structures without pointers into the physical memory structure and the physical memory structure, and wherein unused space in the physical memory structure is tracked using a combination of a free-list and metadata organized as bit vectors.

29. The graphics processor of claim 22, wherein the virtualized multiple physical structures comprise one or more of: a register file, a plane equation table, a primitive mapping table, thread descriptor queues, a graphics state table, a first level instruction cache, a first level data cache, a first level constant cache, a texture cache, and a second level cache.

30. The graphics processor of claim 22, wherein the electronic device comprises a mobile electronic device, and wherein the mobile electronic device comprises one or more of a mobile telephone, a tablet device, a wearable device and a mobile computing device.
